(19) United States
(12) Patent Application Publication
(10) Pub. No.: US 2021/0026163 A1
(43) Pub. Date: Jan. 28, 2021

(54) SEGMENTED VARIABLE CONTROLLED ELECTRO-OPTIC ELEMENT

(71) Applicant: GENTEX CORPORATION, Zeeland, MI (US)

(72) Inventors: Stephen F. Richlich, Holland, MI (US); Mathew A. Koppey, Holland, MI (US); Gerald W. Redwine, Holland, MI (US); David M. Ellis, Holland, MI (US); Joel A. Stray, Hudsonville, MI (US)

(21) Appl. No.: 16/938,313

(22) Filed: Jul. 24, 2020

Related U.S. Application Data
(60) Provisional application No. 62/878,387, filed on Jul. 25, 2019.

(51) Int. Cl. G02F 1/01; B60J 1/08; B60K 35/00; B60J 1/02; B60J 3/04; B60R 16/023; B64C 1/14

(52) U.S. Cl. CPC G02F 1/0121; G02F 1/0102; B60J 1/08; B60K 35/00; B60K 2370/1529; B60J 3/04; B60R 16/023; B64C 1/1484; B60J 1/02

(57) ABSTRACT

An electro-optic element includes first and second spaced-apart transparent substrates defining respective opposite, aligned first and second edges, a first bus including a first electrode disposed along an inner surface of the first substrate adjacent the first edge and a second electrode disposed along an inner surface of the second substrate adjacent the first edge, and a second bus including a first electrode disposed along an inner surface of the first substrate adjacent the second edge and a second electrode disposed along an inner surface of the second substrate adjacent the second edge. The first bus and second bus are spaced apart along widths of the first and second substrates between the respective first and second edges. An electro-optic medium is disposed between the first and second transparent substrates, including between the first and second electrodes of the first bus and the second bus, respectively.

### CROSS REFERENCE TO RELATED APPLICATIONS

This application claims the benefit of and priority to U.S. Provisional Patent Application No. 62/878,387, filed on Jul. 25, 2019, entitled Segmented Variable Controlled EC element, the entire disclosure of which is hereby incorporated herein by reference.

### TECHNOLOGICAL FIELD

The present disclosure relates generally to an electro-optic element and more particularly, to an electro-optic element with two separated busses independently controllable to implement separate darkened and transparent sections.

### SUMMARY

According to an aspect of the present disclosure, an electro-optic element, may comprise first and second spaced-apart transparent substrates, each of the first and second transparent substrates defining respective opposite first and second edges, the first edges and second edges of the first and second substrates being substantially aligned; a first bus including a first electrode may be disposed along an inner surface of the first substrate adjacent the first edge and a second electrode may be disposed along an inner surface of the second substrate adjacent the first edge; a second bus including a first electrode may be disposed along an inner surface of the first substrate adjacent the second edge and a second electrode may be disposed along an inner surface of the second substrate adjacent the second edge, the first bus and second bus being spaced apart along widths of the first and second substrates between the respective first and second edges, the second bus spaced apart from the first bus; and an electro-optic medium may be disposed between the first and second transparent substrates, including between the first and second electrodes of the first bus and the second bus, respectively.

A controller may be configured to be in selective electrical communication with the first bus and the second bus; and the controller may be configured to vary a configuration of an electrical connection with the first bus and the second bus and to adjust a relative level of voltage between the first bus and the second bus. The controller may be configured to selectively apply a first voltage to the first electrode of the first bus, a second voltage having an opposite polarity to that of the first voltage to both the first electrode of the second bus and the second electrode of the first bus, and no voltage to the second electrode of the second bus, thereby causing a darkened region to extend from the second bus and a transparent region to extend from the first bus, a transition region may extend between the darkened region and the transparent region. The controller may be configured to selectively apply a first voltage to the first electrode of the first bus and the second electrode of the second bus and to apply a second voltage having an opposite polarity to that of the first voltage to the second electrode of the first bus and the first electrode of the second bus, thereby causing a darkened region to extend from both the first and the second bus. The electro-optic element further may comprise a third bus including a first electrode may be disposed along an inner surface of the first substrate adjacent a third edge and a second electrode may be disposed along an inner surface of the second substrate adjacent the third edge; the controller may be configured to vary a configuration of an electrical connection with the third bus and to adjust a level of voltage delivered to the third bus. The electro-optic element may be disposed in one of a windshield and a side window of a vehicle. The electro-optic element may be disposed in a window assembly of an airplane. The electro-optic element may be disposed in a heads-up display in a vehicle.

According to another aspect, an electro-optic assembly, may comprise an electro-optic element, including first and second spaced-apart transparent substrates, each of the first and second transparent substrates defining respective opposite first and second edges, the first edges and second edges of the first and second substrates being spaced apart; a first bus adjacent the first edges; a second bus adjacent the second edges, the first bus and second bus being spaced apart from and generally parallel to one another.

An electro-optic medium may be disposed between the first and second transparent substrates and in electrical communication with the first bus and the second bus. A controller may be in electrical communication with the first bus and the second bus and configured to: vary a configuration of an electrical connection with the first bus and the second bus; and adjust a relative level of voltage between the first bus and the second bus.

Varying the configuration of the electrical connection with the first bus and the second bus may include at least one of: independently connecting and disconnecting the first and second busses with a power source; connecting the first and second busses with the power source at opposite polarities; and partially connecting one of the first and second busses with the power source. Each of the first bus and the second bus may include a first electrode disposed along an inner surface of the first substrate and a second electrode disposed along an inner surface of the second substrate. Connecting the first and second busses with the power source at opposite polarities includes connecting the first electrode of the first bus to a first pole of the power source and the first electrode of the second bus to an opposite pole of the power source; and partially connecting one of the first and second busses with the power source may include disconnecting the second electrode of the one of the first and second busses from the power source with the first and second busses connected with the power source at opposite polarities. The controller may be configured to vary the configuration of the electrical connection with the first bus and the second bus to selectively cause sections of the electro-optic medium to independently change between respective darkened and transparent states; and adjust the relative level of voltage between the first bus and the second bus to move a location of at least one transition of the sections relative to the first bus and the second bus. The controller may be configured to vary the configuration of the electrical connection and adjust the relative level of voltage based on user inputs received regarding the configuration of the sections and the location of the at least one transition. The electro-optic assembly further may comprise a third bus including a first electrode disposed along an inner surface of the first substrate adjacent a third edge and a second electrode may be disposed along an inner surface of the second substrate adjacent the third edge. The controller may be configured to vary a configuration of an electrical connection with the third bus and to adjust a level of voltage delivered to the third bus. The third bus may be spaced apart from the second bus and the first bus; and the first bus may be spaced apart from the second bus. The electro-optic assembly may be disposed in one of a windshield and a side window of a vehicle. The electro-optic assembly may be disposed in a window assembly of an airplane. The electro-optic assembly may be disposed in a heads-up display in a vehicle.

According to another aspect, a method for defining separate transparent and darkened sections in an electro-optic element, may comprise varying a configuration of an electrical connection with a first bus and a second bus on opposite lateral sides of the electro-optic element to selectively cause sections of an electro-optic medium in electrical communication with the first and second busses to independently change between respective darkened and transparent states; and adjusting a relative level of voltage between the first bus and the second bus to move a location of at least one transition of the sections relative to the first bus and the second bus.

According to another aspect of the disclosure, a vehicle includes at least one of a windshield and side window incorporating an electro-optic assembly including an electro-optic element having first and second spaced-apart transparent substrates, each of the first and second transparent substrates defining respective opposite first and second edges. The first edges and second edges of the first and second substrates are substantially aligned. The electro-optic element further has a first bus adjacent the first edges and a second bus adjacent the second edges. The first bus and second bus are spaced apart along widths of the first and second substrates between the respective first and second edges. An electro-optic medium is disposed between the first and second transparent substrates and in electrical communication with the first bus and the second bus. The assembly further includes a controller in electrical communication with the first bus and the second bus and configured to vary a configuration of an electrical connection with the first bus and the second bus and adjust a relative level of voltage between the first bus and the second bus.

According to another aspect of the disclosure, an airplane window assembly includes a pressure pane, a bezel surrounding the pressure pane, and a dust cover including an electro-optic assembly including an electro-optic element having first and second spaced-apart transparent substrates, each of the first and second transparent substrates defining respective opposite first and second edges. The first edges and second edges of the first and second substrates are substantially aligned. The electro-optic element further has a first bus adjacent the first edges and a second bus adjacent the second edges. The first bus and second bus are spaced apart along widths of the first and second substrates between the respective first and second edges. An electro-optic medium is disposed between the first and second transparent substrates and in electrical communication with the first bus and the second bus. The assembly further includes a controller in electrical communication with the first bus and the second bus and configured to vary a configuration of an electrical connection with the first bus and the second bus and adjust a relative level of voltage between the first bus and the second bus.

According to another aspect of the disclosure, a method for defining separate transparent and darkened segments in an electro-optic element includes varying a configuration of an electrical connection with a first bus and a second bus on opposite lateral sides of the electro-optic element to selectively cause segments of an electro-optic medium in electrical communication with the first and second busses to independently change between respective darkened and transparent states. The method also includes adjusting a relative level of voltage between the first bus and the second bus to move a location of at least one transition of the segments relative to the first bus and the second bus.

These and other features, advantages, and objects of the present device will be further understood and appreciated by those skilled in the art upon studying the following specification, claims, and appended drawings.

### BRIEF DESCRIPTION OF THE DRAWINGS

FIG. 1 is a schematic plan view of an electro-optic assembly according to an aspect of the disclosure;

FIG. 2 is a schematic edge elevation view of the electro-optic assembly of FIG. 1;

FIG. 3 is a plan view of the electro-optic assembly of FIG. 1 in a first configuration of transparent and darkened sections;

FIG. 4 is a plan view of the electro-optic assembly of FIG. 1 in a second configuration of transparent and darkened sections;

FIG. 5 is a plan view of the electro-optic assembly of FIG. 1 in a fully darkened state;

FIG. 6A is a schematic plan view of an electro-optic assembly according to a further aspect of the disclosure;

FIG. 6B is a schematic edge elevation view of the electro-optic assembly of FIG. 6A;

FIG. 7 is an interior view of a vehicle including one or more electro-optic elements in a first configuration;

FIG. 8 is the interior view of the vehicle including one or more electro-optic elements of FIG. 7 in a second configuration;

FIG. 9 is a plan view of an airplane window assembly including an electro-optic element in a first configuration;

FIG. 10 is a plan view of the airplane window assembly including the electro-optic element of FIG. 9 in a second configuration;

FIG. 11 is a plan view of the electro-optic assembly in another configuration of transparent and darkened sections; and

FIG. 12 is a plan view of the electro-optic assembly in yet another configuration of transparent and darkened sections.

### DETAILED DESCRIPTION OF EMBODIMENTS

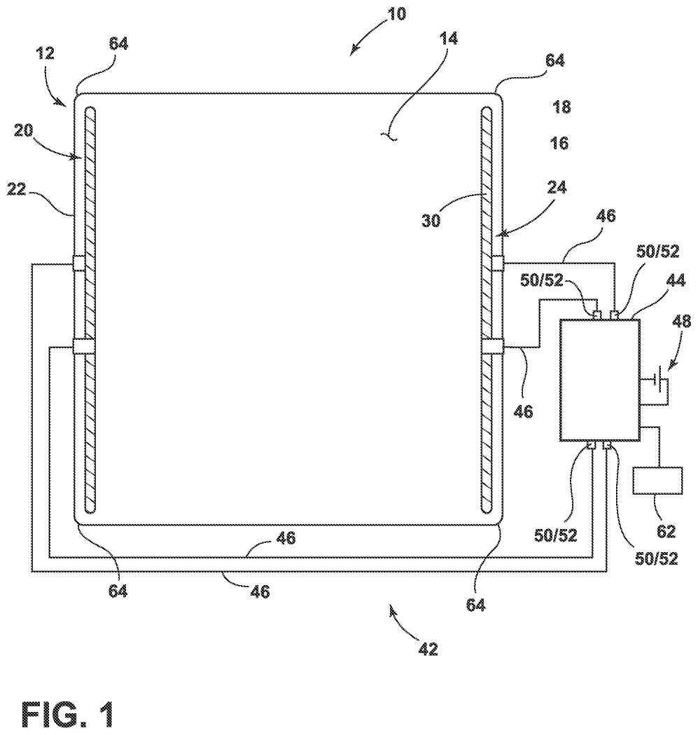

Referring to the drawings, FIGS. 1-5 depict an electro-optic element 10. In the illustrated example, the electro-optic element 10 includes first and second spaced-apart transparent substrates 12, 14. Each of the first and second transparent substrates 12, 14 defines respective opposite first edges 16, 18 and second edges 20, 22. The first edges 16, 18 and second edges 20, 22 of the first and second substrates 12, 14 are substantially aligned. In some embodiments, first edges 16, 18 of first and second substrates 12, 14 may be substantially parallel with and spaced apart from second edges 20, 22 of first and second substrates 12, 14. One or more layers of electrically conductive material or electrode coatings 23 may be associated with an inner surface 28 of first substrate 12. These layers may serve as a first electrode for electro-optic element 10. Similarly, one or more layers of electrically conductive material or electrode coatings 25 may be associated with and disposed on an inner surface 32 of second substrate 14 and may operate as a second electrode for electro-optic element 10. Electrode coating 23 may be a material that is substantially transparent in the visible region of the electromagnetic spectrum. Electrode coating 23 may be fabricated from fluorine doped tin oxide (FTO), indium/tin oxide (ITO), doped zinc oxide or other materials known to those having ordinary skill in the art.

The electro-optic element 10 further includes a first bus 24 including a first electrode 26 disposed along the inner surface 28 of the first substrate 12 adjacent the first edge 16 and a second electrode 30 disposed along the inner surface 32 of the second substrate 14 adjacent the first edge 18 and a second bus 34 including a first electrode 36 disposed along the inner surface 28 of the first substrate 12 adjacent the second edge 20 and a second electrode 38 disposed along the inner surface 32 of the second substrate 14 adjacent the second edge 22. The first bus 24 and second bus 34 are spaced apart along widths of the first and second substrates between the respective first 16, 20 and second edges 18, 22. An electro-optic medium 40 may be disposed between the first and second transparent substrates 12, 14, including between the first 26, 36 and second electrodes 30, 38 of the first bus 24 and the second bus 34, respectively. An encapsulant 41 surrounds and helps to retain the electro-optic medium 40 between the substrates 12, 14, and electrically insulates the first 26, 30 and second 36, 38 electrodes from each other.

The electro-optic medium 40 disposed between the first and second substrates 12, 14 may include at least one solvent, at least one anodic material, and at least one cathodic material. Typically, both of the anodic and cathodic materials are electroactive and at least one of them may be electro-optic. It will be understood that regardless of its ordinary meaning, the term “electroactive” will be defined herein as a material that undergoes a modification in its oxidation state upon exposure to a particular electrical potential difference. Additionally, it will be understood that the term “electro-optic” will be defined herein, regardless of its ordinary meaning, as a material that exhibits a change in its extinction coefficient at one or more wavelengths upon exposure to a particular electrical potential difference. Electro-optic components, as described herein, include materials whose color or opacity are affected by electric current, such that when an electrical current is applied to the material, the color or opacity changes from a first phase to a second phase. The electro-optic component may be a single-layer, single-phase component, multi-layer component, or multi-phase component. The busses 24, 34 provide electric current to the electrode coatings 23, 25 to generate an electrical potential therebetween. The electro-optic medium can be of various compositions generally known in the art that vary in transparency from substantially transparent to substantially opaque with the application of an electrical potential thereto. As can be appreciated, such compositions are generally used in connection with various windows, mirrors, and the like in an arrangement with a single bus having two opposed electrodes surrounding the substrates such that a potential applied over the electrodes in the single bus causes darkening or dimming (or other optical adjustment of the associated assembly) in a uniform manner.

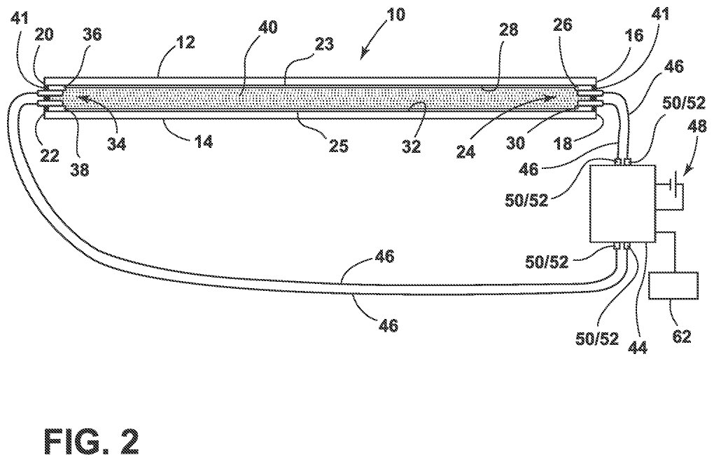

As illustrated in FIGS. 1 and 2, the present electro optic element 10 can be included in an electro-optic assembly 42 that is configured to provide functionality related to the use of the two, separated, busses 24, 34 of the depicted electro-optic element 10. In particular, in addition to the electro-optic element 10, the assembly 42 includes a controller 44 in electrical communication with the first bus 24 and the second bus 34. The controller 44 may be configured to vary a configuration of an electrical connection with the first bus 24 and the second bus 34 and to adjust a relative level of voltage between the first bus 24 and the second bus 34. As shown, the controller 44 can be connected with each of the first bus 24 and the second bus 34 by the depicted wires 46, with each of the respective first and second electrodes 26, 30, 36, 38 being independently connected with the controller 44 (inclusive of the wires being provided in pairs in various arrangements and associated with the first bus 24 and second bus 34. In this manner, controller 44 can vary the configuration of the electrical connection with the first bus 24 and the second bus 34 by independently connecting and disconnecting the first and second busses 24, 34 with a power source 48 in different manners and at varying voltages. In particular, controller 44 can connect the first and second busses 24 and 34 with the power source 48 at opposite polarities (e.g., the first electrode 26 and second electrode 30 of the first bus 24 connected with power source 48 to be respectively positively and negatively charged and the first electrode 36 and second electrode 38 of the second bus 34 connected with power source 48 to be respectively negatively and positively charged). Further, controller 44 can connect the first bus 24 with the power source 48, for example such that the first electrode 26 and second electrode 30 are respectively positively and negatively charged, the first electrode 36 of the second bus 34 is negatively charged, and the second electrode 38 of the second bus 34 is disconnected from the power source 48. In this manner, it can be said that controller 44 can partially connect the second bus 34 with the power source 48. Such arrangements are exemplary and can be implemented in different variations according to the principles discussed herein.

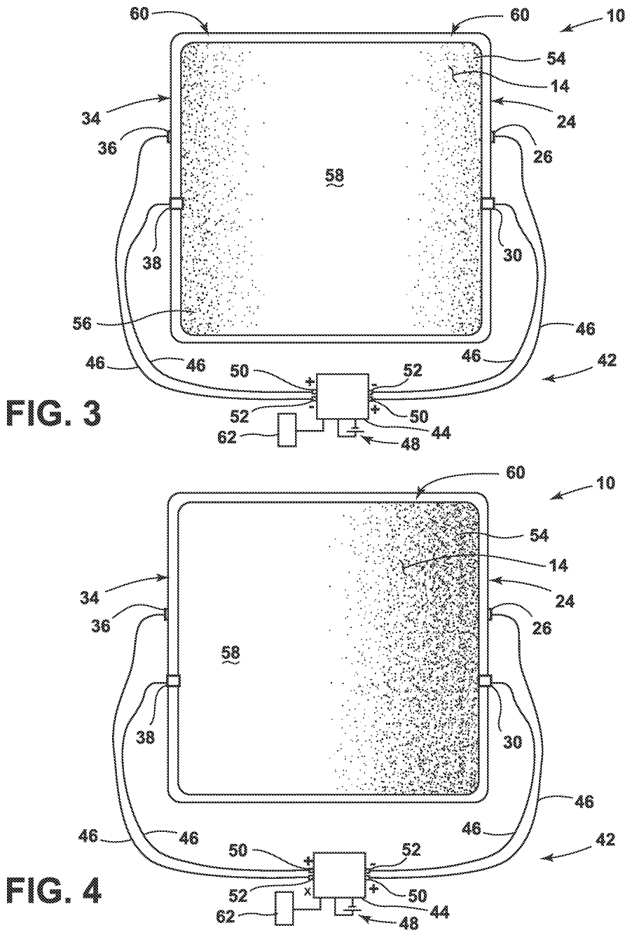

As shown in FIGS. 3-5, the above-described variation of the connection of busses 24 and 34 with power source 48 by controller 44 can provide variations in the darkening effect realized in the electro-optic medium 40 across the span of the electro-optic element 10 between the first bus 24 and the second bus 34. In particular, the controller 44 is configured to vary the configuration of the electrical connection with the first bus 24 and the second bus 34 to selectively cause various segments of the electro-optic medium 40 to independently change between respective darkened and transparent states (with various transition portions therebetween being present in certain configurations, as discussed below). As shown in FIG. 3, connecting the first bus 24 and the second bus 34 with the power source 48 at opposite polarities can be achieved by connecting the first electrode 26 of the first bus 24 to a first pole 50 (e.g. positively-charged) of the power source 48 and the first electrode 36 of the second bus 34 to an opposite pole 52 (i.e., negatively-charged) of the power source 48. In this manner, the controller 44 also connects the second electrode 30 of the first bus 24 to the negatively-charged pole 52 and the second electrode 38 of the second bus 34 to the positively-charged pole 50 of the power source 48. The result of such a connection configuration is such that the electro optic medium 40 includes a first darkened section 54 adjacent to and extending from first bus 24 and a second darkened section 56 adjacent to and extending from second bus 35 with a transparent section 58 disposed between the darkened sections 54 and 56. As illustrated, the darkened sections 54, 56 transition gradually to the transparent section 58 such that the overall effect is of a gradient between the sections 54, 56, 58. In such a configuration, controller 44 can vary the levels of the potential (voltage level) applied over each of the busses 24, 34 individually. In one respect, increasing the potential to either of the busses 24, 34 can increase the distance by which the respective darkened section 54, 56 extends from the bus 24, 34. In one aspect, this can cause the transparent section 58 between the darkened sections 54, 56 to decrease in width. Further, the absolute levels of the polarities can be varied between the first bus 24 and the second bus 34 to cause the respective darkened sections 54, 56 to have different widths, with the darkened sections 54, 56 associated with the higher absolute potential (i.e. regardless of the particular orientation: positive or negative) having a greater width in the associated section 54 or 56.

As shown in FIG. 4, a similar opposite connection between the first electrode 26 of the first bus 24 and the first electrode 36 of the second bus 34 can be maintained but with the second electrode 38 of the second bus 34 being disconnected from the power source 44, i.e., the second electrode 38 being “partially” connected, can result in a single darkened section 54 extending from the first bus 24. Since the second electrode 30 of the first bus 24 is still connected, as described above, section 56 adjacent to second bus 34 will not darken. In this configuration, the transparent section 58 is adjacent to and extends from the second bus 34 with a similar gradual transition between sections 54 and 58 resulting in a gradient effect. In such an arrangement, applying a higher voltage to the first electrode 36 of the second bus 34 relative to the first bus 24 can increase the relative width of the transparent section 58. Similarly, with the opposite effect being achieved by applying a higher potential to the first bus 24, the relative width of the darkened section 54 may increase. Further, the application of lower absolute voltages to both busses 24, 34 (the voltage to the second bus 34 being “partial”) may result in an increase of the width of the transition region 60 between the sections 54 and 58, while applying higher absolute voltages may decrease the width of the transition region 60. By reversing the connection, such that second bus 34 is fully connected with the power source 48 and first bus 24 is partially connected at an opposite polarity, the effect can be reversed such that the darkened section 54 is adjacent to and extends from second bus 34 while the transparent section 58 extends from first bus 24.

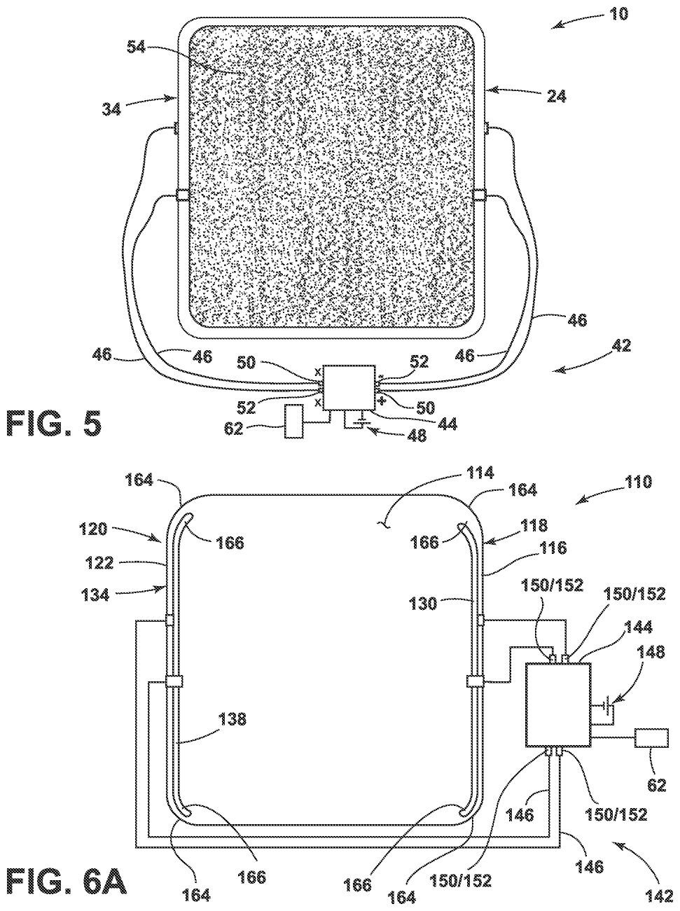

As shown in FIG. 5, by either completely disconnecting the second bus 34 from the power source 48 or by applying the same voltage at the same polarity to both first bus 24 and second bus 34, e.g., applying a positive voltage to both the first pole of the first bus and the first pole of the second bus and applying a negative voltage to both the second pole of the first bus and the second pole of the second bus, the entire electro-optic medium 40 can be made opaque (darkened) by a consistent amount, including to the full extent possible for the particular electro-optic medium (which, in most applications is substantially or nearly completely opaque). In this manner, the controller 44 can be configured to connect either or both of the busses 24, 34, either partially or fully, with power source 44 and to adjust the relative (absolute) levels of voltage applied over the first bus 24 and the second bus 34. This configuration can allow controller 44 to move a location of the transition region 60 of the sections 54, 56, 58 relative to the first bus 24 and the second bus 34. This can be accomplished using an algorithm or other control scheme embedded within controller (including within memory accessible by controller) that builds on or otherwise modifies control schemes for existing, single-bus electro-optic elements. In this manner, the ability to control the relative transparency of various electro-optic media using an applied potential is generally known. Modifications of such control schemes to provide partial connections and to adjust the relative absolute applied voltages as described herein can be derived based on the present disclosure within the framework for controlling the opacity of the particular electro-optic medium 40, in general. Further, controller may be configured to vary the configuration of the electrical connections with busses 24, 34 and to adjusts the relative levels of voltage applied thereto based on user inputs received through an interface 62. The interface 62 can be electromechanical or electronic and can allow for configuration of the electro-optic element 10 with varying configurations of sections 54, 56, or 58, the locations of any associated transition regions 60, and the relative opacity of the darkened sections 54, 56.

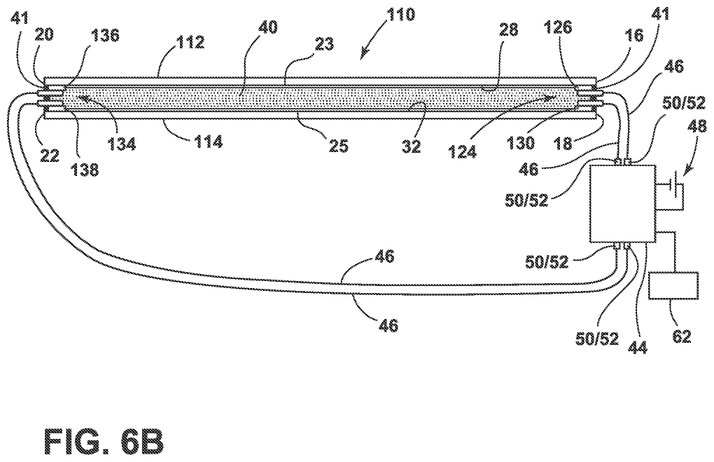

A variation of an electro-optic assembly 142 including an electro-optic element 110 similar to that which is depicted in FIGS. 1 and 2 is shown in FIGS. 6A and 6B. Notably, the electro-optic element 10 of FIGS. 1 and 2 includes relatively sharp corners 64, which may be defined by a radius on the order of about 5 mm or less. In such an embodiment, the electrodes 26, 30, 36, 38 can be generally straight strips of material (in one implementation 2 mm silver bus tape) that extend along the respective edges 16, 18, 20, 22 of the substrates 12, 14 between the corners 64. In some aspects, the electrodes 26, 30, 36, 38 may not extend fully to the corners, but may be spaced therefrom by an amount similar to a spacing away from the respective edges 16, 18, 20, 22. In the embodiment of FIGS. 6A and 6B, the substrates 112, 114 of the electro-optic element 110 include larger corners 164 including with a radius on the order of about 50 mm, and in one embodiment between about 20 mm and about 100 mm (although other dimensions may be possible). The electrodes 126, 130, 136, 138 in the busses 124, 134 associated with electro-optic element 110 include corner extensions 166 that define radii to partially extend into the corners 164 of the respective substrates 112, 114. In various examples, the corner extensions 166 can extend through between about 15° and about 45° and in some embodiments through the full 90° of the respective corners 164. Other geometric modifications of the busses 24, 34, 124, 134 can be made according to the particular geometry of an associated electro-optic element.

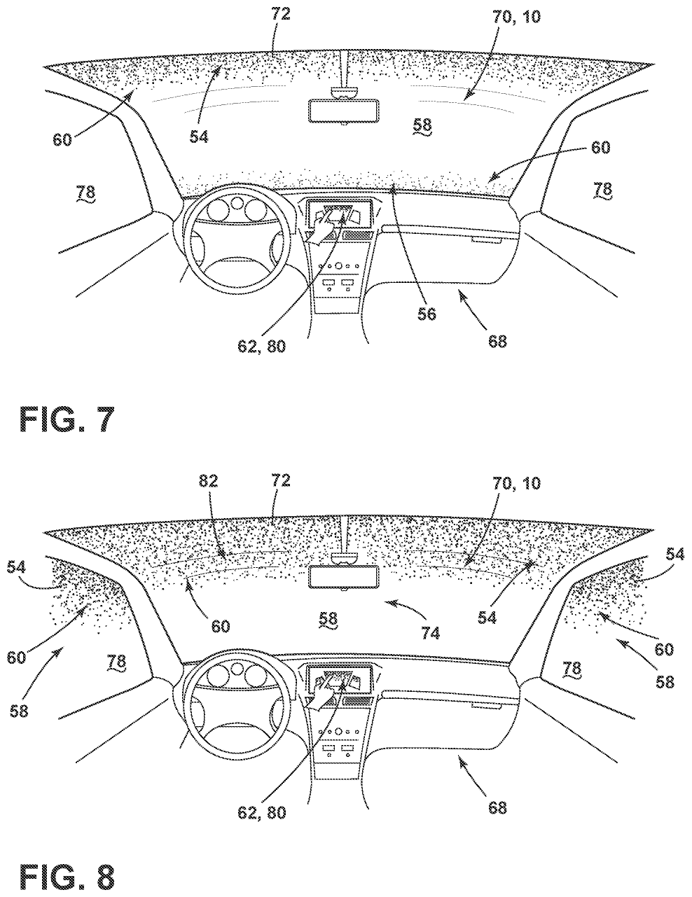

Turning to FIGS. 7 and 8, various implementations of the electro-optic assembly 42 discussed above (including according to the modifications discussed above with respect to FIGS. 6A and 6B) can be used within a vehicle 68 such as an automobile, boat, or airplane. In particular, the depicted vehicle 68 (which is for exemplary purposes only) includes a windshield that can be of an electro-optic element 10 according to the above disclosure. In the illustrated embodiment, the windshield 70 is configured to extend upward into the roof area 72 of the vehicle 68 in a contiguous arrangement with the typical windshield portion 74. In such an arrangement, it may be advantageous to configure the electro-optic element 10 comprising the windshield 70 to be controlled by way of an on-board computer or other integrated controller 44 to provide a darkened section 54 within the roof portion 72, thereby allowing for the effect of a solid roof to block glare from ambient sunlight and to reduce heating of the interior cabin of the vehicle 68, while keeping the windshield portion 74 primarily occupied by a transparent section 58. Such control can be effected by the scheme discussed above with respect to FIG. 4. In a further aspect, it may be beneficial to allow for control of the electro-optic element 10 of windshield 70 to provide an additional darkened section 56 within a lower area 76 thereof to provide additional contrast for projected information on the windshield 70 (e.g. a heads-up display (“HUD”)). Such control can be effected by the scheme discussed above with respect to FIG. 3. As further shown, the vehicle side windows 78 can also incorporate electro-optic elements 10 of a similar construction to those discussed above (including with aspects of electro-optic element 110). As shown in FIG. 8, the electro-optic elements 10 can be controlled according to the scheme discussed above with respect to FIG. 4 to provide a darkened area 54 toward the top area 82 of the side windows 78 with the remaining portion being occupied a transparent section 58. Such a configuration can provide for shading of the upper portions 82 of the side windows 78 to replace a mechanical visor. Similarly, the darkened area 54 of the windshield 70, discussed above, can be extended to a similar upper area 82 of the windshield 70 for similar functionality. As can be appreciated the location of the transition region 60 from the upper darkened areas 54 and the transparent areas 58 can be controlled by the vehicle 68 according to the various control schemes described above. Additionally, the vehicle 68 can be configured to allow for driver and/or passenger control of the electro-optic elements 10 in the windshield 70 and side windows 78 by providing an interface 62 within or accessible by a vehicle-human machine interface (HMI) 80, as further shown in FIGS. 7 and 8.

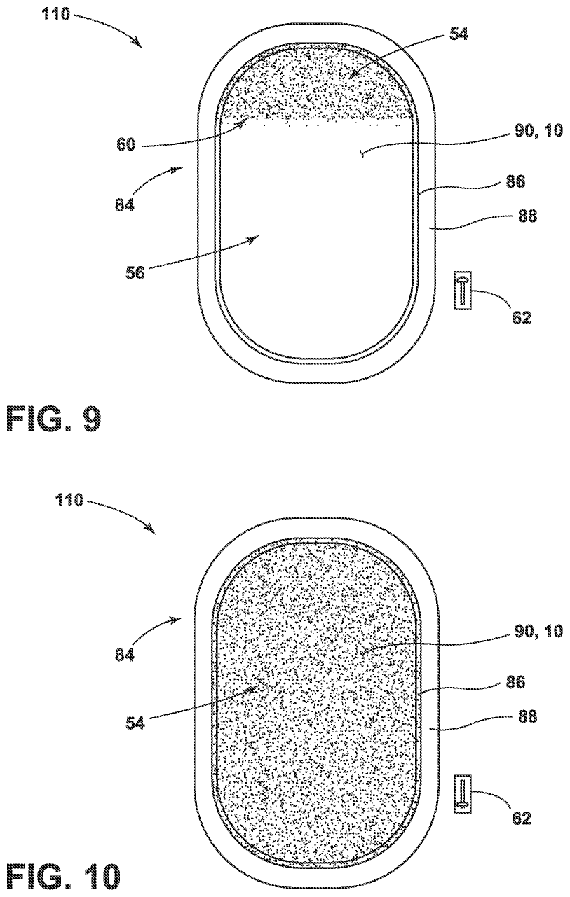

In a further aspect, shown in FIGS. 9 and 10, an airplane window assembly 84 includes an external pressure pane 86 and a bezel 88 surrounding the pressure pane 86. The assembly 84 further includes a dust cover 90 mounted within the bezel 88 and including an electro-optic assembly 42 according to the above disclosure. As shown, the electro-optic assembly 42 can include an electro-optic element 110 that comprises the dust cover 90 such that the present electro-optic element 110 replaces the typical single-sheet plastic commonly used for dust covers in airplane window assemblies. In this manner, the darkening of the electro-optic element 110 can obscure visibility through a selectable portion of the assembly 84 in a manner that replicates the function of a typical sliding screen, which can eliminate the need therefor. As shown, the manipulation of a user interface 62 can allow the passenger to extend a darkened section 154 from the top of the electro-optic element 110 in the dust cover 90 downward (FIG. 9) to the desired point, including so as to fully obscure the pressure pane 86, as shown in FIG. 10.

According to a further aspect, a method for defining separate transparent 56 and darkened 54 sections in an electro-optic element 10, 110 includes varying a configuration of an electrical connection with a first bus 24 and a second bus 34 on opposite lateral sides (defined by edges 16, 18 and edges 20, 22 respectively) of the electro-optic element 10 to selectively cause sections 54, 58 of an electro-optic medium 40 in electrical communication with the first and second busses 24, 34 to independently change between respective darkened and transparent states. Such darkening can be achieved according to the schemes discussed above with respect to FIG. 3-5. The method also includes adjusting a relative level of voltage between the first bus 24 and the second bus 34 to move a location of at least one transition region 60 of the sections 54, 58 relative to the first bus 24 and the second bus 34.

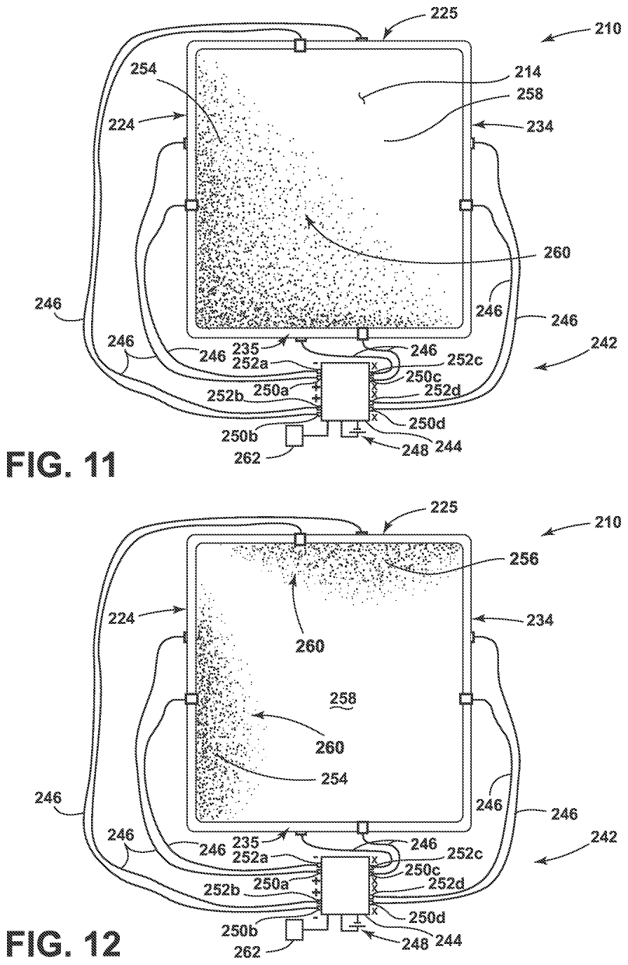

A further variation of an electro-optic assembly 242 incorporating a modified electro-optic element 210 is shown in FIGS. 11 and 12. The illustrated electro-optic element includes additional busses 225 and 235 positioned along edges of the electro-optic element 210 perpendicular to busses 224 and 234 and on opposite sides of the electro-optic element 210 from each other. In general, the additional busses 225 and 235 are of a similar construction to busses 224 and 234 (which themselves are similar to the busses 24 and 34 discussed above, including with respect to the structure and positioning of the corresponding electrodes). In this manner, all four busses 224, 225, 234, 235 can be connected to the illustrated controller 244 to provide for selective connection with a power source 248 in a variety of connections along similar principles to the connection between electrodes 24 and 34 with power source 48, as discussed above. The ends of each of the four busses 224, 225, 234, and 235 may be spaced apart from one another. As illustrated in FIG. 11, controller 244 can connect adjacent busses 224 and 225 with power source 248 such that bus 224 is connected with both poles 250a and 252a of power source 248 and such that bus 225 is oppositely connected with only a single pole 252b. When such a connection is maintained, electro-optic element 210 includes a darkened section 254 adjacent bus 224 and a transparent section 258 adjacent bus 234. Further, the darkened section extends away from bus 225 and along adjacent bus 235 while the transparent section 258 extends outwardly along bus 225 and adjacent bus 234 such that a transition region 260 is defined on a diagonal across electro-optic element 210. Busses 234 and 235 are not provided with power in the above scenario.

As illustrated in FIG. 12, controller 244 can also fully connect adjacent busses 224 and 225 with power source 248 at opposite poles 250, 252 thereof. I.e., controller 244 can connect adjacent busses 224 and 225 with power source 248 such that bus 224 is connected with both poles 250a and 252a or power source 248 and such that bus 225 is connected with both poles 250b and 252b, such that separate darkened sections 254 and 256 extend respectively along the respective busses 224 and 225 with arced transition regions 260 to a central transparent section 258. In further variations, electro-optic element 210 can be connected with power source 248 similarly to electro-optic element 10 in FIGS. 3-5 with busses 225 and 235 being disconnected from power source 248 by controller 244. In this manner, controller 244 can be configured (such as by programming or the like) to connect the various busses 224, 225, 234, 235 with power source 248 in various configurations and to adjust the absolute voltage among the connected busses 224, 225, 234, 235 according to the principles discussed above.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

The above description is considered that of the illustrated embodiments only. Modifications of the device will occur to those skilled in the art and to those who make or use the device. Therefore, it is understood that the embodiments shown in the drawings and described above is merely for illustrative purposes and not intended to limit the scope of the device, which is defined by the following claims as interpreted according to the principles of patent law, including the Doctrine of Equivalents.

What is claimed is:

1. An electro-optic element, comprising:
first and second spaced-apart transparent substrates, each of the first and second transparent substrates defining respective opposite first and second edges, the first edges and second edges of the first and second substrates being substantially aligned;
a first bus including a first electrode disposed along an inner surface of the first substrate adjacent the first edge and a second electrode disposed along an inner surface of the second substrate adjacent the first edge;
a second bus including a first electrode disposed along an inner surface of the first substrate adjacent the second edge and a second electrode disposed along an inner surface of the second substrate adjacent the second edge, the first bus and second bus being spaced apart along widths of the first and second substrates between the respective first and second edges, the second bus spaced apart from the first bus; and
an electro-optic medium disposed between the first and second transparent substrates, including between the first and second electrodes of the first bus and the second bus, respectively.

2. The electro-optic element of claim 1, wherein a controller is configured to be in selective electrical communication with the first bus and the second bus;
wherein the controller is configured to vary a configuration of an electrical connection with the first bus and the second bus and to adjust a relative level of voltage between the first bus and the second bus.

3. The electro-optic element of claim 2, wherein the controller is configured to selectively apply a first voltage to the first electrode of the first bus, a second voltage having an opposite polarity to that of the first voltage to both the first electrode of the second bus and the second electrode of the first bus, and no voltage to the second electrode of the second bus, thereby causing a darkened region to extend from the second bus and a transparent region to extend from the first bus, wherein a transition region extends between the darkened region and the transparent region.

4. The electro-optic element of claim 2, wherein the controller is configured to selectively apply a first voltage to the first electrode of the first bus and the second electrode of the second bus and to apply a second voltage having an opposite polarity to that of the first voltage to the second electrode of the first bus and the first electrode of the second bus, thereby causing a darkened region to extend from both the first and the second bus.

5. The electro-optic element of claim 2, further comprising a third bus including a first electrode disposed along an inner surface of the first substrate adjacent a third edge and a second electrode disposed along an inner surface of the second substrate adjacent the third edge;
wherein the controller is configured to vary a configuration of an electrical connection with the third bus and to adjust a level of voltage delivered to the third bus.

6. The electro-optic element of claim 1, wherein the electro-optic element is disposed in one of a windshield and a side window of a vehicle.

7. The electro-optic element of claim 2, wherein the electro-optic element is disposed in a window assembly of an airplane.

8. The electro-optic element of claim 1, wherein the electro-optic element is disposed in a heads-up display in a vehicle.

9. An electro-optic assembly, comprising:
an electro-optic element, including:
first and second spaced-apart transparent substrates, each of the first and second transparent substrates defining respective opposite first and second edges, the first edges and second edges of the first and second substrates being spaced apart;
a first bus adjacent the first edges;
a second bus adjacent the second edges, the first bus and second bus being spaced apart from and generally parallel to one another; and
an electro-optic medium disposed between the first and second transparent substrates and in electrical communication with the first bus and the second bus; and
a controller in electrical communication with the first bus and the second bus and configured to:
vary a configuration of an electrical connection with the first bus and the second bus; and
adjust a relative level of voltage between the first bus and the second bus.

10. The electro-optic assembly of claim 9, wherein varying the configuration of the electrical connection with the first bus and the second bus includes at least one of:
independently connecting and disconnecting the first and second busses with a power source;
connecting the first and second busses with the power source at opposite polarities; and
partially connecting one of the first and second busses with the power source.

11. The electro-optic assembly of claim 10,
wherein each of the first bus and the second bus includes a first electrode disposed along an inner surface of the first substrate and a second electrode disposed along an inner surface of the second substrate;
wherein connecting the first and second busses with the power source at opposite polarities includes connecting the first electrode of the first bus to a first pole of the power source and the first electrode of the second bus to an opposite pole of the power source; and
wherein partially connecting one of the first and second busses with the power source includes disconnecting the second electrode of the one of the first and second busses from the power source with the first and second busses connected with the power source at opposite polarities.

12. The electro-optic assembly of claim 9, wherein the controller is configured to:
vary the configuration of the electrical connection with the first bus and the second bus to selectively cause sections of the electro-optic medium to independently change between respective darkened and transparent states; and
adjust the relative level of voltage between the first bus and the second bus to move a location of at least one transition of the sections relative to the first bus and the second bus.

13. The electro-optic assembly of claim 12, wherein the controller is configured to vary the configuration of the electrical connection and adjust the relative level of voltage based on user inputs received regarding the configuration of the sections and the location of the at least one transition.

14. The electro-optic assembly of claim 9, further comprising a third bus including a first electrode disposed along an inner surface of the first substrate adjacent a third edge and a second electrode disposed along an inner surface of the second substrate adjacent the third edge;
wherein the controller is configured to vary a configuration of an electrical connection with the third bus and to adjust a level of voltage delivered to the third bus.

15. The electro-optic assembly of claim 14, wherein the third bus is spaced apart from the second bus and the first bus; and
wherein the first bus is spaced apart from the second bus.

16. The electro-optic assembly of claim 9, wherein the electro-optic assembly is disposed in one of a windshield and a side window of a vehicle.

17. The electro-optic assembly of claim 9, wherein the electro-optic assembly is disposed in a window assembly of an airplane.

18. The electro-optic assembly of claim 9, wherein the electro-optic assembly is disposed in a heads-up display in a vehicle.

19. A method for defining separate transparent and darkened sections in an electro-optic element, comprising:
varying a configuration of an electrical connection with a first bus and a second bus on opposite lateral sides of the electro-optic element to selectively cause sections of an electro-optic medium in electrical communication with the first and second busses to independently change between respective darkened and transparent states; and
adjusting a relative level of voltage between the first bus and the second bus to move a location of at least one transition of the sections relative to the first bus and the second bus.
